(19) United States
(12) Patent Application Publication
(10) Pub. No.: US 2022/0273127 A1
(43) Pub. Date: Sep. 1, 2022

(54) SYSTEMS, DEVICES AND METHODS FOR GENERATING FRUIT JUICE WITH SELF CLEANING

(71) Applicant: Juceee excite LTD, Nazareth (IL)

(72) Inventors: Salim NIMRE, Nazareth (IL); Rabei IBRAHIM, Nazareth (IL)

(21) Appl. No.: 17/631,974

(22) PCT Filed: Aug. 1, 2020
(86) PCT No.: PCT/IL2020/050845

§ 371 Date: Feb. 1, 2022

Related U.S. Application Data
(60) Provisional application No. 62/881,865, filed on Aug. 1, 2019.

(51) Int. Cl. A47J 19/02; B08B 3/02; B08B 7/02; B26D 7/06

(52) U.S. Cl. CPC A47J 19/023; B08B 3/02; B08B 7/02; B26D 7/06; A47J 2201/00; B08B 2230/01

(57) ABSTRACT

The present invention relates to a novel fruit juicer, specifically a citrus fruit juicer.

### FIELD OF THE INVENTION

The present invention generally relates to devices, machines, systems and methods for generating fruits' juice, and more particularly for generating juice from citrus fruits, said devices and systems are equipped with a cutting & squeezing unit designed to simultaneously cut and squeeze a citrus fruit and perform automatic self-cleaning operation in sealed container.

### BACKGROUND OF THE INVENTION

Citrus fruits are a healthy and nutritional component in the diet. One favorite consumption manner of citrus fruits is by juicing them and drinking their juice. However, due to the inconvenience of manual juicing, many refrain from squeezing a fresh cup of juice and prefer to buy pre-juiced containers. Accordingly, many attempts were made to develop automatic citrus fruit juicers.

Preliminary attempts were based on the simple manual squeezing procedure, which requires the user to first cut the citrus fruit in half and place each half on a conic shape for squeezing. The squeezing was performed by: (i) manually or mechanically pressing the cut fruit onto a motorized conic shape that spins; or (ii) using a mechanical presser to enhance the pressure on the cut fruit and squeeze. In both techniques, the citrus's peel and remaining fibers need to be removed after squeezing is complete.

In addition, several squeezing machines were developed in order to obviate manual labor, such as small machines for general fruit squeezing or larger commercial machines for citrus fruit squeezing. However, even such machines suffer from several disadvantages. For instance, small squeezing machines often require manual labor for adding the fruits therein, after manual peeling thereof. The larger, commercial, machines have their own disadvantages, such as high price tag; and large size which does not fit regular household kitchens. In addition, these devices still require manual cleaning daily; and do not enable pulp separation.

WO 2018/042440 has tried overcoming all of the above disadvantages, and more, by providing a small-sized squeezing device that uses a digger mechanism for squeezing the citrus fruits without the need to cut or peel the citrus prior to the squeezing.

Accordingly, a need exists for a revolutionary fruit juicer, which overcomes all of the above disadvantages and others, while enabling simple and programmable juicing according to one's desire and schedule (e.g. remote activation or predefined time for juicing), that provides automatic and effective cleaning procedures upon completion of squeezing, and that enable almost no maintenance.

### SUMMARY OF THE INVENTION

The present invention provides a juicer comprising: (a) a citrus fruits container; (b) a waste vessel; (c) at least one cooling unit coupled with said citrus fruits container and said waste vessel; (d) a simultaneous cutting & squeezing unit constructed as a sealable container, comprising: a presser, and a cutting & squeezing base 208 comprising at least one cutter; (e) a citrus transportation system for delivering each citrus fruit from said citrus fruits container to said simultaneous cutting & squeezing unit; (f) a sensor for identifying the presence of a citrus fruit at said cutting & squeezing unit; (g) optionally, a pump coupled to said cutting & squeezing unit; and (h) a self-cleaning system associated with a water source, comprising: at least one sprinkler and/or vapor cleaning unit, and optionally a scrubbing unit; and (i) a computing system comprising a processor and a memory, adapted to receive data from said sensor, and for operating said cutting & squeezing unit and said self-cleaning system.

In specific embodiments, the juicer is a citrus juicer designed to simultaneously cut and squeeze citrus fruits.

### BRIEF DESCRIPTION OF THE DRAWINGS

FIGS. 1A-1C are illustrations of a juicer of the invention: FIG. 1A is a 3D view; FIG. 1B is a cross-sectional view of FIG. 1A; and FIG. 1C is a side view of FIG. 1B.

FIGS. 2A-2C illustrate different components of a juicer of the invention.

FIGS. 3A-3D illustrate the cutting & squeezing unit.

FIGS. 4A-4C are close ups of a cutting & squeezing pyramid-shaped base showing the sharp edges/knifes thereon: FIG. 4A is a side-view; FIG. 4B is a 3D enlargement of the tip of the base of FIG. 4A; and FIG. 4C is an illustration of the basis of the base showing vapor cleaning nuzzles.

FIGS. 5A-5E illustrate the rotation of the lower section of the cutting & squeezing unit after squeezing for disposal of fruits' remains to the waste vessel.

FIG. 6 is a flowchart illustrating the mechanism of action of the juicer of the invention.

### DETAILED DESCRIPTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention provides systems, devices, and methods for creating juice from various fruits, especially citrus fruits. Accordingly, the present invention provides a citrus juicer 100, which simultaneously cuts and squeezes the citrus fruits to generate juice therefrom.

The present invention is superior over known juicers and depicts a system that performs automatic and simultaneous cutting and squeezing of a fruit, such as citrus fruits, followed by a self-cleaning procedure using an integrated self-cleaning mechanism. The present invention further provides a compact and size efficient fruit squeezing machine. The system/juicer 100 of the invention is novel in that the operations of cutting and squeezing of the fruit are carried out simultaneously, by using a unique cutting & squeezing unit 104. In specific embodiments, the cutting & squeezing unit 104 has a pyramid/dome-shaped squeezing base 208 equipped with sharp edges/knifes 221 and an opposite equivalent-shaped presser 207. After the cutting & squeezing step, the part holding the remaining peel and fruit's debris is rotated, e.g., about 180°, to remove the remaining peel to a garbage/waste container 102. The rotation may be accompanied by a vibration action to aid in the release of the debris. After all fruits have been squeezed, the presser 207 and base 208 are brought together to form a confined compartment for self-cleaning thereof. The cleaning is achieved by using pressurized water and/or steam, optionally accompanied by organic or regular soap. The fact that the cleaning is carried out in a confined, sealed, space, means that only a small amount of water is needed, and that the generated steams are under pressure, which reduces the amount of energy needed therefor (i.e. for the boiling of the water).

Accordingly, the present invention provides a juicer 100, specifically a citrus-fruits' juicer that is designed to simultaneously cut and squeeze citrus fruits, said juicer 100 comprises: (a) a citrus fruits' container 101; (b) a waste vessel 102; (c) a cooling unit coupled with said citrus fruits container 101 and said waste vessel 102; (d) a simultaneous cutting & squeezing unit 104 constructed as a sealable container, comprising: a presser 207, and a cutting & squeezing base 208 comprising at least one cutter 221; (e) a citrus transportation system 103 for delivering each citrus fruit from said citrus fruits container 101 to said simultaneous cutting & squeezing unit 104; (f) a sensor for identifying the presence of a citrus fruit, e.g. at said cutting & squeezing unit; (g) optionally, a pump coupled to said cutting & squeezing unit for pumping generated squeezed juice to a collection vessel 210; and (h) a self-cleaning system associated with a water source, comprising: at least one sprinkler and/or vapor cleaning unit, and optionally a scrubbing unit; and (i) a computing system comprising a processor and a memory, adapted to receive data from said sensor, and for operating said cutting & squeezing unit and said self-cleaning system.

In certain embodiments, the citrus juicer 100 of the invention comprises: (a) a citrus container 101; (b) a waste vessel 102, divided into a solid compartment 215 and a fluid compartment 209; (c) an upper 207 and lower 208 pyramid-shaped cutting & squeezing unit 104; (d) a citrus transportation system 103 for delivering each citrus fruit from said citrus container 101 to a juicing point, i.e. the cutting & squeezing unit 104, said transportation system 103 comprises at least one of: (i) a stoppage/blocking unit 212, (ii) a pushing unit, (iii) a rail 216 attached to spring 217 that bounces when both parts of the cutting & squeezing unit 104 attach or detach; and a citrus fruit rotation mechanism; (e) a pressing piston for current and squeezing 201; (f) rotary piston 205 for throwing away the citrus fruit leftovers after cut and squeeze; (g) a self-cleaned tube 206 for delivering squeezed juice to a collection cup 210; (h) a computing system, comprising a processor and a memory, adapted to receive user request, process data from all units and perform cutting/squeezing, cleaning, and validations; and (i) a self-cleaning system for cleaning said cutting & squeezing unit 104, comprising: a water source, vacuum components 214; and at least one sprinkler and/or vapor cleaning unit(s) 219.

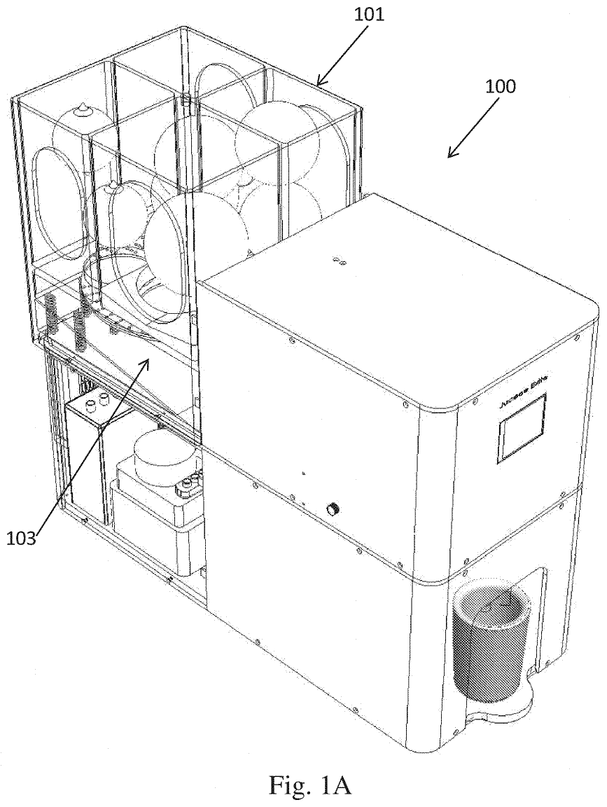

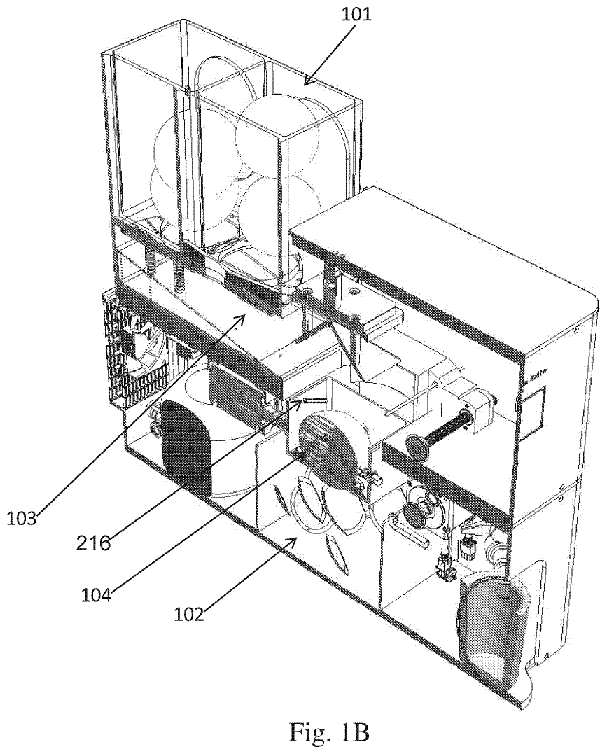

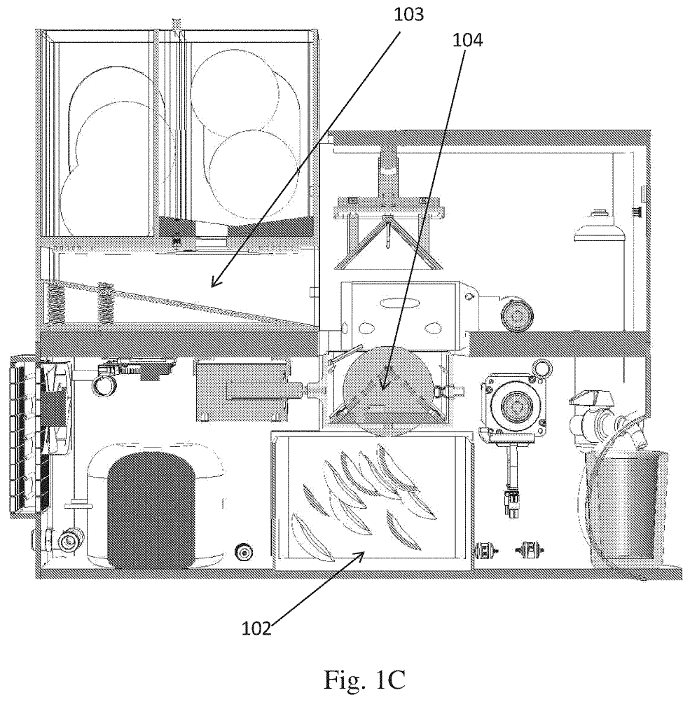

In certain embodiments, the fruits' container 101 is divided/separated into several areas/regions, each one for holding the same or different fruit type. FIG. 1 illustrates such a fruits' container 101 divided to four individual area, each holding a different fruit type.

The juicer 100 of the invention is designed for home usage, and thus is designed to be small scaled to fit on the counter without taking too much space. Since the fruits are stored in a chilled fruits' container 101, the generated fresh juice is also cool and ready for drinking. Moreover, the generated juice may also be stored until consumption in a chilled container, so that the juice can be prepared in advance to actual consumption, e.g. according to predetermined program, so a person can wakeup in the morning and have a ready-to-drink fresh squeezed juice. Accordingly, in specific embodiments, the juicer 100 of the invention is controlled by a dedicated application in a remote computer (e.g. smartphone) connected wirelessly via, e.g., Wi-Fi, or via a touch LCD located thereon.

The waste vessel 102 may be divided into two compartments—one for solids and the other for liquid, thereby eliminating undesired effects (e.g. fermentation) due to leaving solid leftovers in a liquid environment, which may result with unpleasant odors. To further reduce such undesired effect, the waste vessel 102 may by kept chilled using said cooling unit, or using an additional/secondary cooling unit. The waste vessel 102 may also be connected to a dispensing tube (and optionally a pump) for draining liquids to, e.g., the sewer. Such tube (and pump) may be activated automatically when the level of liquids reaches a certain level and/or during the juicing process. In certain embodiments, the juicer 100 or waste vessel 102 further comprises a compressing unit for compressing the solid waste to reduce the required space for the solid waste.

The cooling unit of the juicer 100 be associated with any one of: the fruit's container 101, the waste vessel 102, and a juice vessel 210 holding the freshly squeezed juice, or any combination thereof. The cooling unit is designed to maintain a constant temperature at the different areas of the juicer, which may be the same or different for each area: for instance, the fruits' container 101 may be kept at a temperature of about 10-15° C., while the waste vessel 102 is kept at a temperature of about 4° C. In specific embodiments, the juicer 100 does not have a cooling unit.

The juicer's simultaneous cutting & squeezing unit 104 is designed to enable gripping of a fruit delivered from the fruit's container 101 and subsequently cut it while squeezing it. The unit 104 is constructed as a sealable container so as to enable easy and simple self-cleaning thereafter. The unit 104 is comprised of a presser 207 element and a cutting & squeezing base 208 element comprising at least one cutter 221. Notably, although the presser 207 is referred herein as the component that is moved towards the base 208, it is understood by a skilled artisan that the presser 207 may be still while the base 208 is component moved towards the presser 207. Alternatively, both the presser 207 and the base 208 may be moved together one toward the other. For clarity purposes and to avoid confusion, but without limiting the scope of the invention, the description herein refers to the presser as the one being moved towards the base.

When the presser 207 pushes the fruit against the base 208, the sharp edges 221 on the base pierce the fruit's peel and expose the inside thereby enabling juice to exit the fruit's peel as the presser 207 continues to push the fruit against the base 208. In certain embodiments, the cutting & squeezing base 208 further comprises a shredder. In alternative embodiments, the base 208 is a shredder. Such a shredder assists in the squeezing of the fruit as it is pressed against the base 208 and in the generation of pulp. Since pulp is not always desired, depending on personal preferences, the base 208 may further comprise a strainer (filter) to remove such pulp and optional leftovers. The strainer may have different sieve sizes to enable separation of pulp from large leftovers, and from different sized pulp. The strainer may be located at any desired location, such as at the bottom of the base, at the opening or end of a tube delivering the juice, or before a pump that pumps the juice, or any combination thereof.

As noted above, the juicer 100 has a self-cleaning mechanism. Accordingly, when the juicer 100 includes such a strainer, the juicer 100 further includes a strainer clearing unit that is either part of the self-cleaning system or is an independent unit optionally connected thereto.

In certain embodiments, the citrus juicer 100 further comprises an independent juice and pulp separation unit for separating pulp from the squeezed juice according to desire. Such a separation unit may use centrifugal force and any other suitable technique to separate the pulp from the juice.

In certain embodiments, the juicer 100 further comprises a strainer clearing unit for removal of, e.g., pulp that accumulates thereon during juicing. Non-limiting examples of such clearing unit are: (i) a viper; and (ii) a reverse flow mechanism that pushes accumulated pulp away from the strainer.

In certain embodiments, the citrus juicer of the invention further comprises an integral power source. In a specific embodiment, said power source is rechargeable, thereby enabling the juicer 100 to be mobile.

The juicer's citrus transportation system 103 is designed to deliver each time a single (citrus) fruit from the fruits container 101 to the simultaneous cutting & squeezing unit 104. The transportation system 103 may comprise sensors for identifying that the fruits' container 101 is empty and/or the presence of a fruit stuck somewhere in the transportation pathway and optionally sending an alert when identifying that the fruits' container 101 is empty and/or that a fruit is stuck somewhere along the transport. Additionally, the sensors may identify that a fruit has been delivered to the cutting & squeezing unit 104 and that the pressing of the fruit can begin.

In order to deliver a fruit from the container 101 to the simultaneous cutting & squeezing unit 104, the transportation system 103 may comprise a pushing unit for pushing an individual fruit from the container and optionally at certain locations along the transport to bring the fruit to the cutting & squeezing unit 104. Such a pushing unit may be a spring, a piston (electric, pneumatic, etc.) or air blower. The transportation system 103 may also be based on gravity, meaning that the fruits roll out of the container 101 by gravity. In addition, the transportation system 103 may further comprise a stoppage/blocking unit 212 that prevents fruits from exiting the container 101 until they need to be squeezed—it may also assist in selecting the fruit type by opening a specific area of the container holding the desired fruits' type. The transportation system 103 may further comprise a vibration mechanism that assists in the transport/rolling of the fruits along the way. In certain embodiments, the transportation system 103 comprises a conveyance unit, such as a rail.

In certain embodiments, the transportation system 103 further comprises a fruit rotation means for rotating the fruit to be in a desired orientation/angle when placed in the cutting & squeezing unit 104, which is preferred for the cutting and squeezing process in which case it also includes a sensor for identifying the fruit's orientation, e.g. a camera. Such an angle can be when the fruit's bottom or stem faces the tip of the cutting & squeezing unit 104.

The cutting & squeezing unit 104 of the juicer of the invention is unique in that it simultaneously performs the cutting and the squeezing of a fruit, such as a citrus fruit. Known juicers require that a citrus fruit is first cut in half and then each half is squeezed to generate juice, e.g. by mere squeezing or by adding a rotating base. However, this requires three separate mechanisms—one for the cutting, another for the transport of the two half fruit, and a third for the squeezing—all of which need to work in synergism and coordination. Contrary to such known devices, the present juicer 100 and its unique cutting & squeezing unit 104 make such mechanisms redundant.

The cutting & squeezing unit 104 is designed to receive an un-cut fruit, in any orientation and angle and hold it in place, and then simultaneously cut and squeeze the fruit by advancing a presser 207 towards a cutting & squeezing base 208. The fruit's peel is designed to be cut open by at last one cutter 221 located on the base 208 so that juice obtained by squeezing the fruit against the base 208 can exit the fruit's peel and into a collection vessel 210. The number and orientation of the at last one cutter 221 can vary and there can be two, three, four, five, six or more cutters. The distribution of the cutters 221 on the base can be either an even distribution, in which case the distance between two adjacent cutters is identical, or not. The cutters 221 may be stretched all across the base 208—from bottom to top, or only part way through, or both.

In certain embodiments, the cutting & squeezing unit 104 comprises a pressing piston 201 for squeezing, e.g. for advancing the presser 207. The piston 201 may push the presser 207, the base 208, or both towards one another.

The size of the cutting & squeezing unit 104 may vary according to need and desire. For instance it may be sized to fit small fruits, such as lemons, mandarins, kiwifruit and tomato or larger to fit oranges, pomegranate and even grapefruits.

The shape of the cutting & squeezing unit 104 may also vary, and can be square, rectangle, oval, cylindered, or any other shape. In any case, the cutting & squeezing base 208 and the presser 207 are designed to fit one another. In specific embodiments, the base 208 and presser 207 are dome-shaped. In alternative specific embodiments, and as illustrated in the figures, the base 208 and presser 207 are pyramid-shaped. In further specific embodiments thereof, the pyramid-shape is trilateral, quadrilateral, pentagonal, hexagonal, heptagonal, octagonal, or of any other polygon-shape.

After a fruit is cut and squeezed, the leftovers of the fruit need to be removed from the cutting & squeezing unit 104. Accordingly, the unit 104 may further comprise, or be associated with, a rotary piston 205 for rotating part of the cutting & squeezing unit 104, e.g. the base 208, for disposing fruit's leftovers residing thereon after being cut & squeezed into the waste vessel 102, and then rotating said part back to its original position for, e.g. receiving the next fruit or for further cleaning by the self-cleaning mechanism. In specific embodiments, the rotary piston 205 is designed also to vibrate the rotating part during (or after) rotation to facilitate removal of any leftover therefrom. Alternatively, an additional, separate, vibration mechanism may be used.

As explained above, the cutting & squeezing unit 104 comprises a base 208 and a presser 207 designed to press a fruit in between for simultaneously cutting and squeezing thereof. The location and orientation of the base 208 and presser 207 relative to one another can be: (1) the base 208 may be positioned underneath the presser 207, in which case the rotary piston 205 is associated with the cutting & squeezing base 208; (2) the presser 207 may be positioned underneath the base 208, in which case the rotary piston 205 is associated with the presser 207; or (3) the base 208 and presser 207 are positioned horizontally (facing one another and not one above the other), in which case the rotary piston 205 is associated with the presser 207 or the base 208, or both.

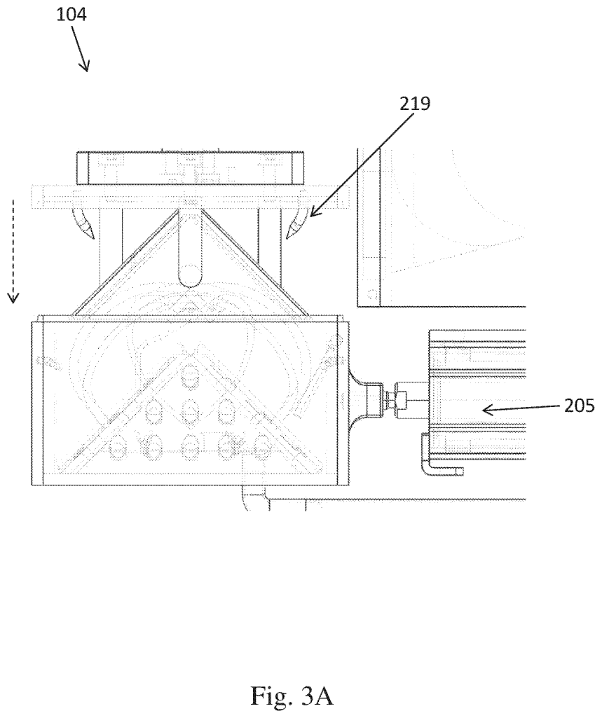

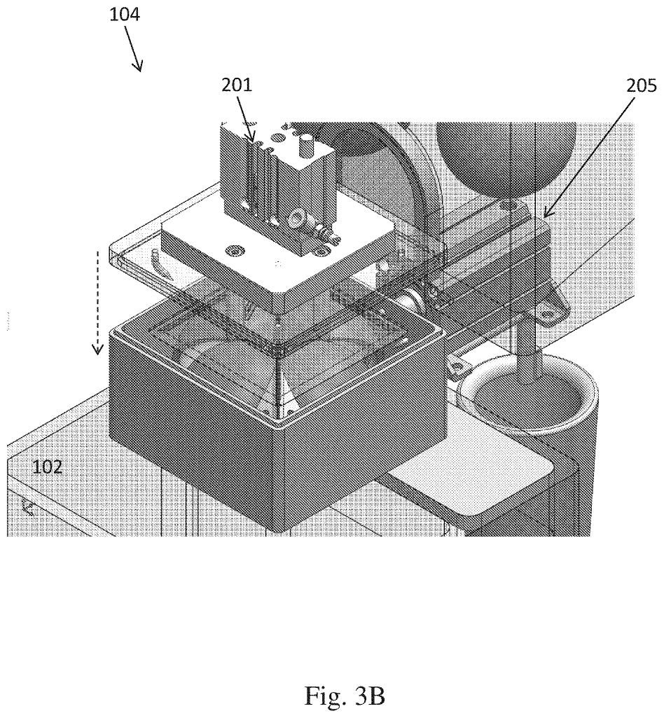

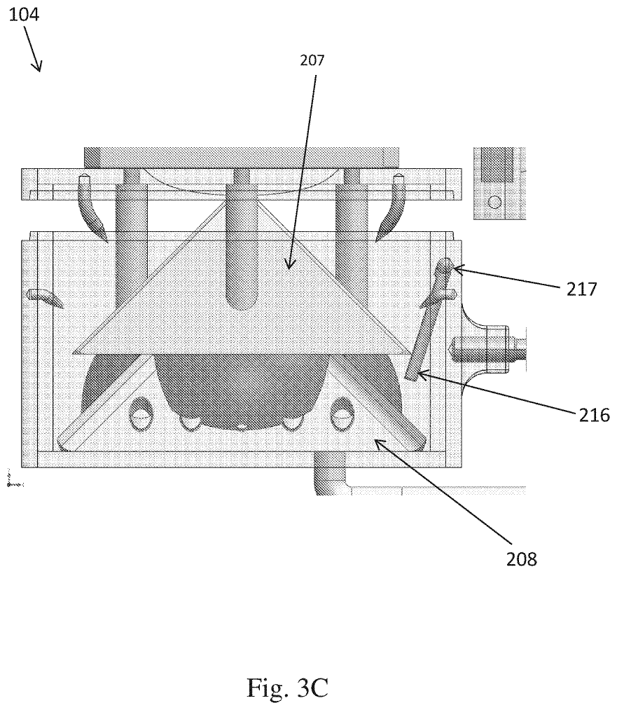

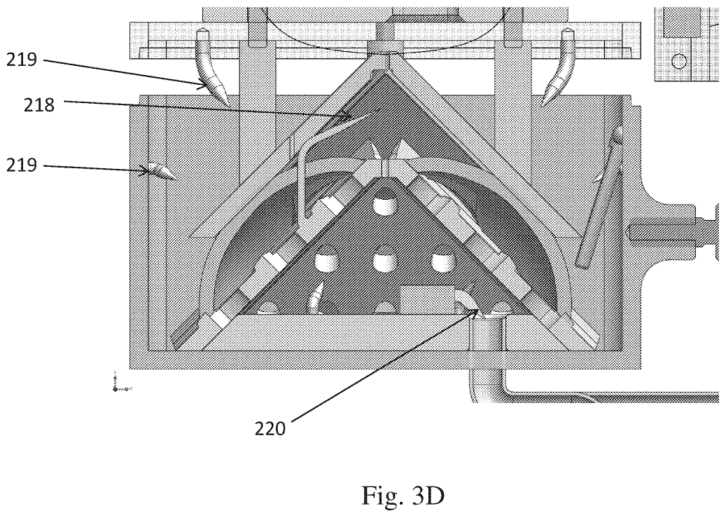

In certain embodiments, the cutting & squeezing unit 104 further comprises securing means 218 for holding the fruit in place until the cutting & pressing begins and optionally during thereof. Non-limiting examples of such securing means is a frame around the lower part that prevents the fruit from falling thereof, a gripper for holding the fruit until the presser 207 creates enough pressure to hold the fruit against the base 208, a needle at the presser 207 or the base 208, or both (see 218 in FIGS. 3D & 4B) that is designed to penetrate into the fruit and hold it in place, and vacuum.

In specific embodiments, the cutting & squeezing base 208 is positioned underneath the presser 207, the rotary piston 205 is associated with the base 208, and the base 208 comprises a needle 218 or set of needles for holding the fruit. In further specific embodiments, the presser 207 also comprises a needle. In alternative specific embodiments, the cutting & squeezing base 208 is positioned above the presser 207, the rotary piston 205 is associated with the presser 207, and the presser 207 comprises a frame for holding the fruit. In further alternative embodiments, the base 208 and presser 207 are positioned horizontally, and both comprise a needle or the unit 104 further comprises a griper, for holding the fruit.

The juicer 100 of the invention is characterized by having a self-cleaning unit/system for cleaning the squeezing area and all associated tubes and pumps (including a strainer when present), which reduces the need for manual cleaning of the machine after each use and reduces the risk of contamination and clogging. The self-cleaning system is associated with a water source—either an external, e.g. a water tap, or internal, such as an internal water container. In specific embodiments, the self-cleaning system further comprises or is associated with, an organic or regular soap container designed to provide cleaning liquid during the cleaning. The juicer may further comprise water filter and/or heater/chiller for providing hot water to the self-cleaning system or cold water to, e.g., the squeezed juice of an ice-flake machine.

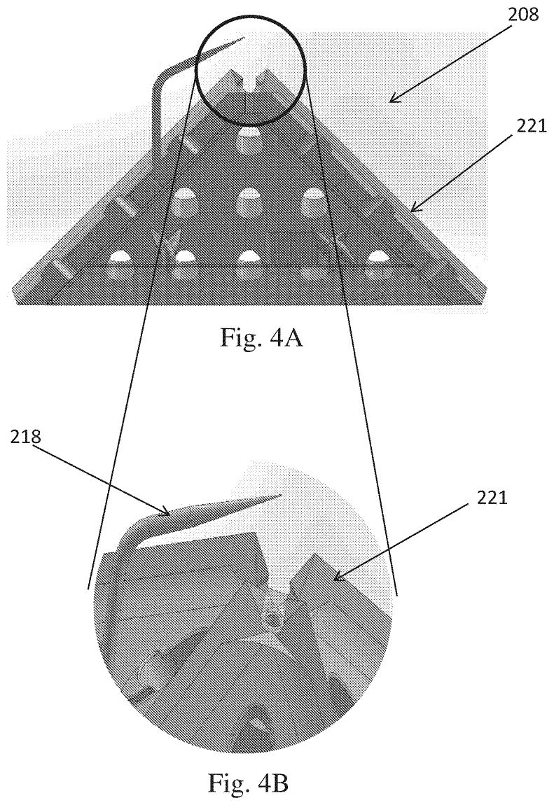

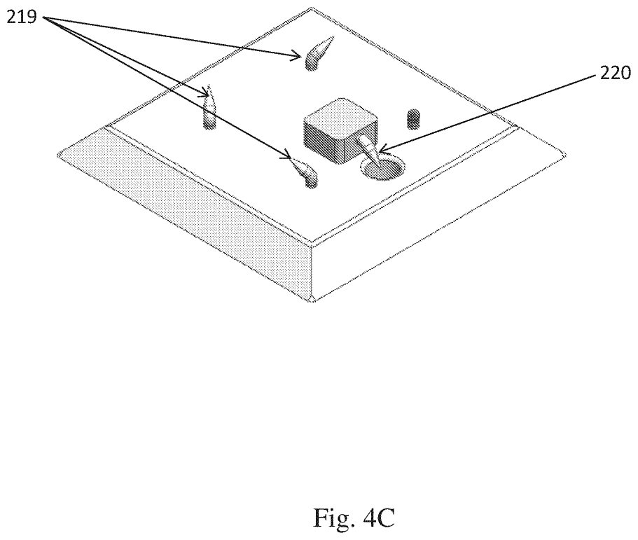

In specific embodiments, the self-cleaning system comprises a vacuum generator 214, e.g. for generating vacuum within the cutting & squeezing unit 104 and/or tubes prior to the cleaning step, and/or for extraction of water out of the unit 214 and tubes after each cleaning cycle. In further specific embodiments, the self-cleaning system comprises at least one sprinkler and/or vapor cleaning unit 219 designed to deliver steam and/or pressurized water into the cutting & squeezing unit 104 for cleaning thereof (FIG. 4C).

In certain embodiments, the juicer 100 further comprises a heater for heating the water needed for the self-cleaning system.

Notably, when pressed together, the presser 207 and the cutting & squeezing base 208 create a sealed container that can be easily cleaned by the self-cleaning system. The fact that they create a sealed container enables using pressurized water and reduces the boiling temperature of the water within the chamber thereby cleaning with boiled water and/or steam.

In certain embodiments of the juicer 100 of the invention, after cutting & squeezing each (citrus) fruit, the rotary piston 205 rotates the lower part of the cutting & squeezing unit (onto which the fruit's leftovers are placed) for disposing fruit's leftovers after being cut & squeezed into the waste vessel 102, and then rotates it back to its original position. After all desired fruits have been squeezed, the presser 207 and cutting & squeezing base 208 are pressed together to create a sealed container for cleaning by the self-cleaning system, which pumps steam and/or (hot) water into the sealed container via dedicated sprinkler(s)/opening(s) 219,220. Then, the water with waste is discharged, e.g., into the waste vessel—either after separating the presser 207 and the base 208, or before, e.g. through a dedicated tube or a tube through which the fresh squeezed juice exits.

In specific embodiments, when the presser 207 and cutting & squeezing base 208 are positioned horizontally to one another, after cutting & squeezing each (citrus) fruit, a vibration mechanism vibrates both the presser 207 and the base 208 for disposing fruit's leftovers after being cut & squeezed into the waste vessel 102. After all desired fruits have been squeezed, the presser 207 and base 208 are pressed together to create a sealed container for cleaning by the self-cleaning system, which pumps steam and/or (hot) water into the sealed container via dedicated sprinkler(s)/opening(s) 219,220. Then, the water with waste is discharged into the waste vessel by separating the presser 207 and the base 208.

In certain embodiments, the citrus juicer 100 of the invention further comprises a vibration mechanism for releasing of fruit's leftovers stuck onto the cutting & squeezing unit 104. This vibration mechanism may be part of the rotary piston 205 or a function thereof. The vibration may be applied onto the part that is being rotated by the rotary piston 205, if present, or on both the presser 207 and cutting & squeezing base 208, e.g., when they face one another horizontally.

In certain embodiments, the cutting & squeezing unit 104 is associated with a tube 206 and optionally with a pump for delivering the freshly squeezed juice to a collection vessel 210 (e.g. cup). The tube 206, when present, is connected to the self-cleaning system for cleaning thereof, e.g. using a dedicated nuzzle 220. In certain embodiments, the juicer 100 further comprise an intermediate juice collection chamber, which is coupled to a pump and/or tube 206 if present, and is optionally maintained chilled by said cooling unit until consumed by the user.

In certain embodiments, the juicer 100 of the invention is modular, thus enabling easy parts replacement for, e.g. repair and/or improvements or modifications of the juicer. This feature enables the user to easily plug and unplug modular parts of the juicer, e.g. due to a malfunction, for maintenance and fixing thereof. In specific embodiments, the system is monitored worldwide, and follows malfunction reports and parts replacements, thereby enabling to anticipate when a certain part needs to be replaced before it actually fails, and optionally send the user a new replacement part in advance as part of the service.

In certain embodiments of the juicer 100 of the invention, the computing system comprises a processor and a memory communicatively coupled to the processor comprising computer-readable instructions that when executed by the processor cause the computing system to execute instructions adapted to manage and monitor the different components of the juicer 100. In specific embodiments, the computing system is adapted to receive user request, process data from the juicer's components, and perform a simultaneous cutting and squeezing of the fruit(s), and self-cleaning.

In certain embodiments, the juicer 100 of the invention further comprises at least one self-monitoring sensor for measuring the performance of the different components of the juicer 100, and/or to allow deep learning, either on a remote server or within the computing system of the juicer, for predicting malfunction/failure in advance, for sensing amount of leftovers in the waste vessel, the amount of water in the water source, amount of fruits in the fruit's container, temperature, cleanliness, etc.

In certain embodiments, the citrus juicer 100 of the invention further comprises any fruit and vegetable juicer unit for creating juice from all kinds of fruit and vegetable. Said juicer unit may be fluidly connected with the pump or may be connected to a different pump or simply use gravitation or pouring of the squeezed juice to the serving vessel 210,

In certain embodiments, the juicer 100 of the invention further comprises a special serving vessel or container for collecting the squeezed juice. In another specific embodiment, said cooling unit also cools said serving vessel of container so that the juice remains cold until served.

In specific embodiments, the citrus juicer 100 of the invention further comprises an ice flake machine, which creates immediately ice flakes that can be added optionally at different dozes to the squeezed juice based on user's choice. According to some embodiments, the principle of operation of such an ice flake machine/unit is as follows: connecting a water supply to the flake unit, cooling the water, e.g., through a stainless steel pipe, to a temperature of about 3-5° c., spraying the cooled water to a sub-cooled container to create ice, which is then crashed to create the ice flakes, and finally, an Archimedes transmission worm cylinder is used to release the volume of ice flakes to the juice container based on user decision. The icing principle is based on the refrigerating cycle of Andrew Muhl.

In certain embodiments, the citrus juicer 100 of the invention and its computing system are coupled to a central server comprising a central management software designed to conduct deep learning analysis of the usage and behavior of all juicers 100 coupled thereto, for, e.g.: (1) performing predictive maintenance; and (2) preventing and minimizing cyber-attacks on said juicer 100. Accordingly, in another specific embodiment, all communication in- and out-of the citrus juicer 100 is encrypted.

In certain embodiments, upon activation of the citrus juicer 100 of the invention, a citrus fruit is delivered from said fruit container 101 through said citrus transportation system 103 to said cutting & squeezing unit 104. There, the presser 207 and base 208 are pressed together thereby simultaneously cutting and squeezing the fruit that resides between them. The juice is then collected using, e.g., a suction mechanism, i.e. a pump. After the juicing is complete, the presser 207 and base 208 are separated and fruit's debris are removed into the waste vessel 102. Once all fruits have been cut and squeezed, the cutting & squeezing unit 104, and all associated components are cleaned using the self-cleaning system and all waste water are moved either to the waste container 102 or the sewage. In addition, the inner pipes within the juicer 100 may be washed by passing water or water vapor therethrough during the cleaning process (e.g. the water may be drawn via the pipes using a pump). In specific embodiments, the cleaning is performed using soap for additional and thorough cleaning, wherein the soap may be placed within a dedicated soap container coupled to the cleaning unit. It should be noted that any type of soap may be used, such as an organic or regular soap.

In certain embodiments, upon activation of the citrus juicer 100 of the invention, a (citrus) fruit is pushed into a rail, that leads the fruit to a needle 218, e.g. at the top of the base 208, followed by vertical movement of the presser 207 towards the base 208 with the help of a press piston 201, when the fruit is squeezed against the base 208, it is cut, e.g. into 4 pieces depending on the number of sharp edges/knifes 221 and is squeezed simultaneously. The squeezed juice at the base 208 is vacuumed through a tube into a cup 210. Then the presser 207 and base 208 detach, the base is rotated 180° and vibrated to discharge remains to the garbage 102. The base then rotates back 180°. Now, the presser 207 and base 208 are re-attached to form a sealed container that can be cleaned by the self-cleaning system via vapor nipples. Water is then vacuumed and directed toward the garbage or kitchen sink. Dedicated vapor cleaning nipples 220 are used to clean tubes (FIGS. 3D & 4C).

In certain embodiments, the citrus juicer 100 of the invention is made of any suitable material which is non-corrosive, such as plastic, polycarbonate, stainless steel, etc., or any combination thereof. For instance, the cutting & squeezing unit 104 may be made of stainless steel, and all other components from plastic.

In certain embodiments, the citrus juicer 100 of the invention is monitored by Internet of Things (IOT). All data gathered by each juicer 100 flows to a cloud for deep learning and, e.g., to estimate failure in advance. This feature enables prediction of failure, and subsequently shipment of in advance of relevant repair parts or modules to the user, thus providing smooth service and juice flow.

It should be noted that the size and number of specific components of the juicer 100 of the invention can be easily modified according to ones needs and desire. This is obtained due to the modularity of the juicer 100.

Reference is now made to the figures. FIGS. 1A-1C illustrate one possible configuration of a citrus juicer 100 according to the invention, showing a 4-chambered fruit's container 101; a transportation system 103 delivering fruits therefrom to a cutting & squeezing unit 104; and a waste vessel 102.

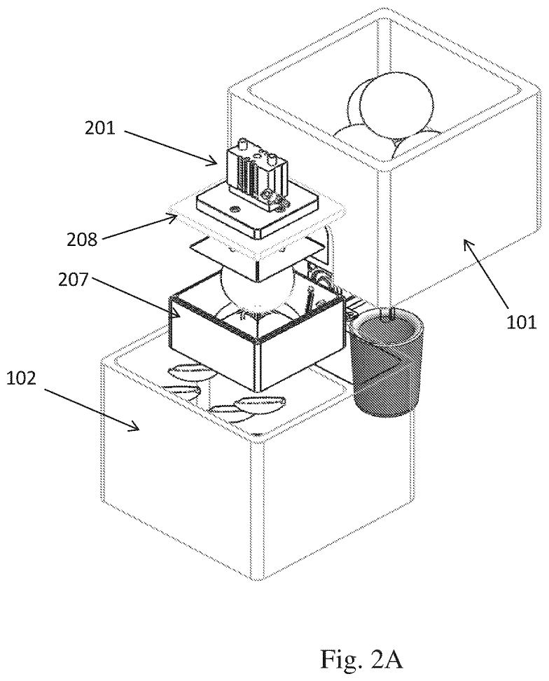

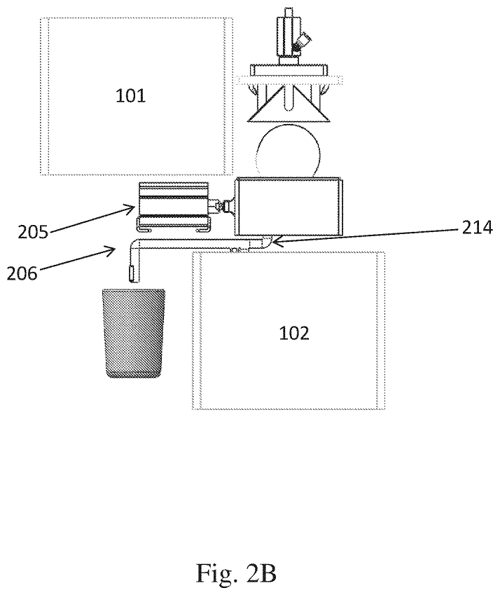

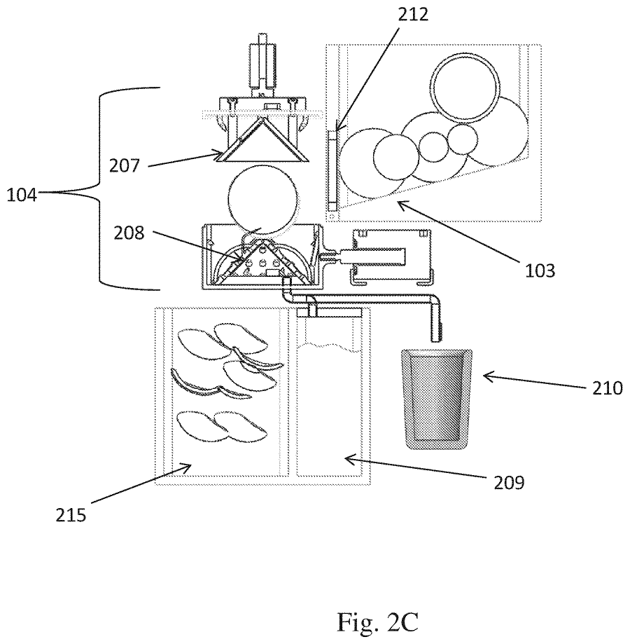

FIGS. 2A-2C illustrate the general concept of the citrus juicer 100 of the invention, emphasizing the different components therein, such as the piston 201 and associated presser 207; the base 208 and the associated rotator 205; the transportation system 103 and associated blocking unit/gate 212; and the divided waste vessel 209,215.

FIGS. 3A-3D illustrate the cutting & squeezing unit 104, showing the rotator 205; the piston 201 and movement of the presser 207 towards the base 208; the vapor cleaning nuzzles 219 and fruit-anchoring needle 218 that is associated with the base 208; and a rail 216 attached to a spring 217 that bounces when the presser 207 and base 208 attach or detach. This rail 216 and spring 217 may serve to indicate that a fruit has been placed in the cutting & squeezing unit 104, that the cutting & squeezing unit 104 is in closed state (e.g. for self-cleaning), as indicator for the rotator 205 to work or stop working, etc., or any combination thereof.

FIGS. 4A-4C focuses on the components of the cutting & squeezing unit 104, illustrating a pyramid-shaped base 208 with four sharp edges/knifes 221 evenly dispersed thereon. As illustrated, the base 208 is constructed as a shredder for assisting in the squeezing process and generation of pulp. FIG. 4C illustrates the basis of the base 208 showing vapor cleaning nuzzles 219 designed to spray vapors/steam or water, optionally with soap, to the base's components for cleaning. Another cleaning nuzzle 220 is directed at cleaning a tube exiting the base, e.g. for delivering the squeezed juice.

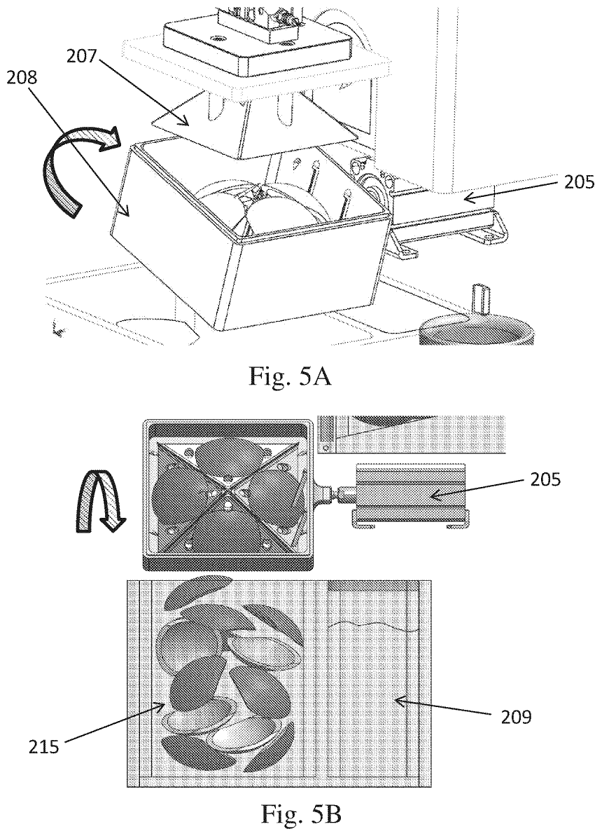

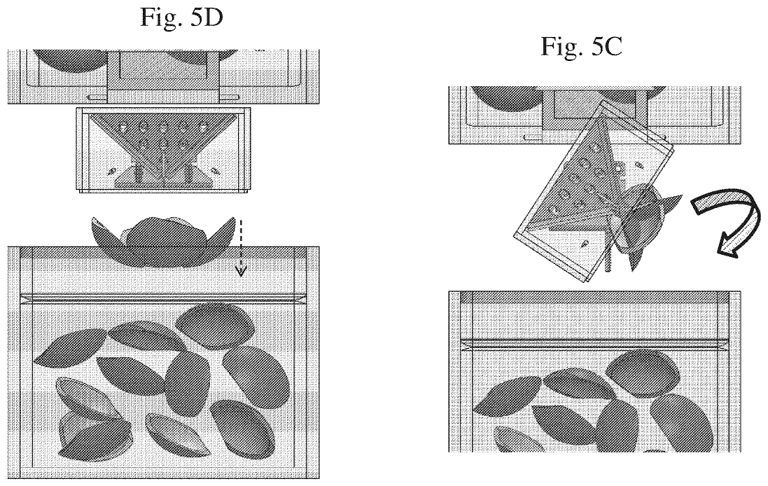

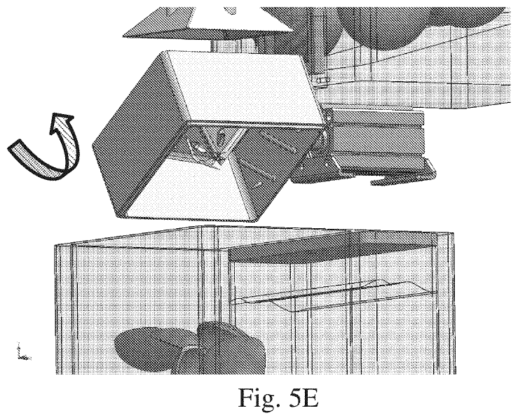

FIGS. 5A-5E illustrate how leftovers of the fruit are disposed from the cutting & squeezing unit 104 to the disposal vessel 102 after each cutting & squeezing cycle. As illustrated, the base 208 is positioned underneath the presser 207, and the rotator 205 is associated with base 208: after a cycle of cutting & squeezing a fruit, the presser 207 is lifted and the base 208 is rotated about 180°, optionally while vibrating to facilitate release of the leftovers from the base 208. After the discharging of the leftovers to the garbage vessel 102 (FIG. 5D), the base 208 is rotated back (FIG. 5E) to its original orientation, ready to receive the next fruit, or for cleaning.

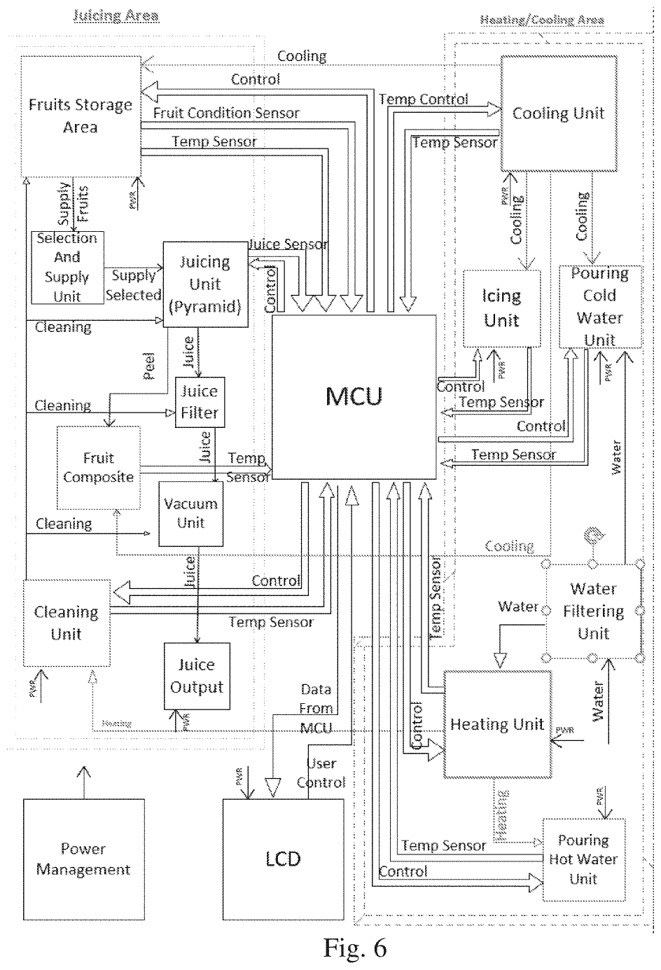

FIG. 6 is a flowchart illustrating the mechanism of action of the juicer 100 of the invention, showing the interactions between the different components of the juicer 100, and the control thereof by the computing system (MCU—micro-controller).

1. A citrus juicer 100 designed to simultaneously cut and squeeze fruits, comprising:
a) a fruits container 101;
b) a waste vessel 102;
c) a cooling unit coupled with said fruits container 101 and said waste vessel 102;
d) a simultaneous cutting & squeezing unit 104 constructed as a sealable container, comprising:
a presser 207, and
a cutting & squeezing base 208 comprising at least one cutter;
e) a citrus transportation system 103 for delivering each fruit from said fruits container 101 to said simultaneous cutting & squeezing unit 104, wherein said citrus transportation system 103 comprises a fruit rotation mechanism;
f) a sensor for identifying the presence of a fruit;
g) optionally, a pump coupled to said cutting & squeezing unit; and
h) a self-cleaning system associated with a water source, comprising:
at least one sprinkler and/or vapor cleaning unit, and
optionally a scrubbing unit; and
i) a computing system comprising a processor and a memory, adapted to receive data from said sensor, and for operating said cutting & squeezing unit and said self-cleaning system.

2. The citrus juicer 100 of claim 1, wherein said citrus transportation system 103 comprises a conveyance unit, a stoppage unit 212, and a pushing unit.

3. (canceled)

4. The citrus juicer 100 of claim 1, wherein said cutting & squeezing unit is designed to receive an un-cut fruit and simultaneously cut and squeeze it by advancing said presser 207 towards said cutting & squeezing base 208, thereby cutting the fruit's peel by said at last one cutter and squeezing the fruit against the base 208 to obtain juice.

5. The citrus juicer 100 of claim 1, wherein said cutting & squeezing unit 104 further comprises: (i) a pressing piston 201 for squeezing; (ii) a fruits' holding means 218 for holding a fruit delivered from the fruits' container 101, and/or (iii) a rotary piston 205 for rotating part of the cutting & squeezing unit 104 for disposing fruit's leftovers after being cut & squeezed into said waste vessel 102, and then rotating said part back to its original position.

6. The citrus juicer 100 of claim 1, wherein said cutting & squeezing base 208 comprises two, three, four, five, six or more cutters, distributed thereon.

7. The citrus juicer 100 of claim 1, wherein said cutting & squeezing base 208 further comprises a shredder or is a shredder.

8. The citrus juicer 100 of claim 1, wherein said cutting & squeezing base 208 and said presser 207: (i) are dome-shaped and fit one another; or (ii) pyramid-shaped and fit one another.

9-11. (canceled)

12. The citrus juicer 100 of claim 5, wherein: (i) said cutting & squeezing base 208 is positioned underneath said presser 207 and said rotary piston 205 is associated with said base 208; or (ii) said presser 207 is positioned underneath said cutting & squeezing base 208 and said rotary piston 205 is associated with said presser 207.

13-14. (canceled)

15. The citrus juicer 100 of claim 1, further comprising: (i) a vibration mechanism for releasing of fruit's leftovers stuck onto the cutting & squeezing unit 104; (ii) an intermediate juice collection chamber, which is coupled to said pump and/or tube 206 if present, (iii) a strainer of a different sieve sizes and optionally a strainer clearing unit; (iv) a compressing unit for compression of fruits' leftovers; and/or (v) at least one self-monitoring sensor.

16. The citrus juicer 100 of claim 1, wherein said self-cleaning system comprises: a vacuum generator 214 and at least one sprinkler and/or vapor cleaning unit 219.

17. The citrus juicer 100 of claim 1, wherein when pressed together, said presser 207 and said cutting & squeezing base 208, create a sealed container.

18. The citrus juicer 100 of claim 1, wherein said waste vessel is split into two containers—one for liquid and one for solid waste.

19. The citrus juicer 100 of claim 1, wherein said cutting & squeezing unit 104 is associated with a tube 206 for delivering squeezed juice to a collection vessel 210.

20-22. (canceled)

23. The citrus juicer 100 of claim 1, wherein said water source is an integral water container.

24. (canceled)

25. The citrus juicer 100 of claim 1, wherein said citrus juicer is modular, enabling easy parts replacement.

26. The citrus juicer 100 of claim 1, wherein said computing system comprises a processor and a memory communicatively coupled to the processor comprising computer-readable instructions that when executed by the processor cause the computing system to execute instructions adapted to manage and monitor the different components of said juicer.

27. The citrus juicer 100 of claim 26, wherein said computing system is adapted to receive user request, process data from the citrus juicer's components, and perform a simultaneous cutting and squeezing of the fruit(s), and self-cleaning.

28. (canceled)
